(19) United States
(12) Patent Application Publication
(10) Pub. No.: US 2009/0017421 A1
(43) Pub. Date: Jan. 15, 2009

(54) Method of Preparing an Artificial Dental Prosthetic and Seating Thereof

(76) Inventor: William F. Letcher, Tulsa, OK (US)

Correspondence Address: HEAD, JOHNSON & KACHIGIAN, 228 W 17TH PLACE, TULSA, OK, 74119, US

(21) Appl. No.: 12/237,133

(22) Filed: Sep. 24, 2008

Related U.S. Application Data
(63) Continuation-in-part of application No. 11/734,138, filed on Apr. 11, 2007.
(60) Provisional application No. 60/863,232, filed on Oct. 27, 2006.

(51) Int. Cl. A61C 8/00

(52) U.S. Cl. 433/201.1

(57) ABSTRACT

An artificial dental prosthetic constructed of a curable resinous dental composition, and a method for preparing and seating the artificial dental prosthetic onto at least one implant in a patient's mouth. The method of preparing the artificial dental prosthetic and seating thereof may be applied to any situation in which one or more artificial dental prosthetic is required, such as a fixed, full artificial dental prosthetic for replacement of a patient's upper and/or lower arches or a fixed, partial artificial dental prosthetic for replacement of a patient's upper and/or lower teeth.

### CROSS-REFERENCE TO RELATED APPLICATIONS

This application is a continuation-in-part of U.S. patent application Ser. No. 11/734,138, filed Apr. 11, 2007, and claims priority to U.S. Provisional Application No. 60/863,232, filed Oct. 27, 2006, both of which are herein incorporated by reference.

### BACKGROUND OF THE INVENTION

1. Field of the Invention

This invention relates generally to a method of preparing an artificial dental prosthetic and seating thereof, and more particularly a method of preparing an artificial dental prosthetic from a curable resinous dental composition and a method of preparing and seating the artificial dental prosthetic directly onto at least one dental implant in a patient's mouth.

2. Description of the Related Art

For persons who have lost an appreciable number of their natural teeth, whether due to disease, decay or other natural or unnatural processes, there is likely to be significant social withdrawal, shame, humiliation and a corresponding loss of dignity. While prosthodontic medicine has greatly enhanced the quality of life of such person's artificial or prosthetic teeth, there remains room for improvement. Traditional dentures, for example, have evolved and undergone substantial improvement in appearance as well as function. However, persons wearing traditional dentures still face a number of problems, including progressive bone loss, inadequate adhesion, poor fit, slippage, unwanted movement, general discomfort, adverse psychological effects, infiltration of food particles, and maintenance.

While composite resin has long been recognized as a useful tooth filling material for anterior or posterior restorations, it has not yet found its way into implant supported prosthodontic applications, such as fixed and removable, partial and full dentures, bridges and other artificial dental prosthetics. The benefits of resin over prior art materials such as acrylics, ceramics and porcelain are numerous. Unlike an artificial dental prosthetic made from porcelain, an artificial dental prosthetic constructed from a curable resinous dental composition is amenable to modifications, such as the addition or removal of material for both aesthetic and functional reasons, using a myriad of filling and drilling techniques even after fully cured and even after the artificial dental prosthetic is in place. This enables a practitioner to make a number of adjustments to accommodate unforeseen or unexpected situations that simply cannot be anticipated through the use of cast molds in the laboratory. Further, resin is available in a number of color variants to aid in the aesthetics of the artificial dental prosthetic. Resin may be cured typically in a matter of minutes, as opposed to oven-baking porcelain.

It is therefore desirable to provide a method of preparing an artificial dental prosthetic and seating thereof that enables a practitioner to provide patients with a long-term, durable, fixed, partial or full artificial dental prosthetic that can be achieved with minimal disruption or inconvenience.

It is further desirable to provide a method of preparing an artificial dental prosthetic and seating thereof utilizing a curable resinous dental composition to construct and seat the artificial dental prosthetic directly onto a patient's dental implant.

It is still further desirable to provide a method of preparing an artificial dental prosthetic and seating thereof that is both functionally and aesthetically superior to prior prosthodontia.

It is yet further desirable to provide a method of preparing an artificial dental prosthetic and seating thereof that may be applied to any situation in which one or more artificial dental prosthetics are required, including but not limited to a fixed, full artificial dental prosthetic for replacement of upper and/or lower arches or a fixed, partial artificial dental prosthetic for partially dentate patients requiring a bridge.

It is yet further desirable to provide a method of preparing an artificial dental prosthetic and seating thereof wherein the artificial dental prosthetic may be seated directly to the patient's dental implants, thus eliminating the need for O-rings, cements, screws, clasps, clips, fasteners or other mounting methods currently employed.

It is yet further desirable to provide a method of preparing an artificial dental prosthetic and seating thereof that eliminates the problems patients experience with slippage and unwanted movement.

It is yet further desirable to provide a method of preparing an artificial dental prosthetic and seating thereof whereby the patient can have the artificial dental prosthetic prepared, finished and seated during the same surgical office visit as the placement of the dental implants.

It is yet further desirable to provide a method of preparing an artificial dental prosthetic and seating thereof that eliminates the cost and inconvenience of having to send molds to a third-party, offsite laboratory, thereby maximizing the efficiency and minimizing the disruption to the patient, such as having to make multiple return trips.

It is yet further desirable to provide a method of preparing an artificial dental prosthetic and seating thereof wherein the artificial dental prosthetic is tapered near a gingival portion so as to keep contact between an intaglio surface of the gingival portion of the artificial dental prosthetic and the gingival soft tissues of the patient's mouth to a minimum, thereby enabling the patient to maintain good oral hygiene.

### SUMMARY OF THE INVENTION

When a patient requiring a fixed, partial or full artificial dental prosthetic appears at the practitioner's office, a computed-tomography scan may be made to view the density and shape of the patient's mandible. The practitioner also makes impressions of the upper and lower arches to establish the vertical dimension and the centric bite for an artificial dental prosthetic. An ideal artificial dental prosthetic is prepared and seated on a study model. Then, a flexible mold is made of the ideal artificial dental prosthetic and surrounding gingiva of the study model.

The practitioner may then surgically place at least one implant into the patient's jaw, and makes an impression of the patient's mouth with the implants. The impression is poured in a dental stone to create a working model. The flexible mold of the ideal artificial dental prosthetic is filled with a curable resinous dental composition and fitted to the working model. The curable resinous dental composition is cured to form the artificial dental prosthetic, which is subsequently removed from the working model. The shaping, polishing and other finishing of the artificial dental prosthetic is then completed. An additional amount of curable resinous dental composition is placed on an intaglio surface of the artificial dental prosthetic, and the artificial dental prosthetic is then seated on the implants surgically placed in the patient mouth. Any excess curable resinous dental composition may be removed. The additional amount of curable resinous dental composition is then cured, thereby fixing the artificial dental prosthetic directly onto the patient's implants. A gingival portion of the artificial dental prosthetic may be trimmed and/or tapered so as to keep contact between the intaglio surface of the artificial dental prosthetic and the patient gingiva to a minimum. This clearance will allow cleansing between the artificial dental prosthetic and the patient's gingiva.

### BRIEF DESCRIPTION OF THE DRAWINGS

FIG. 1 is a perspective view of an example of an ideal artificial dental prosthetic prepared on a study model in accordance with an illustrative embodiment of the method of preparing an artificial dental prosthetic and seating thereof disclosed herein;

FIG. 2 is a perspective view of an example of the ideal artificial dental prosthetic and the study model positioned on a platform of a positive pressure device by which heat and pressure is applied to a sheet of plastic film in accordance with an illustrative embodiment of the method of preparing an artificial dental prosthetic and seating thereof disclosed herein;

FIG. 3 shows the ideal artificial dental prosthetic of FIG. 2 after it has been encapsulated by the sheet of plastic film to create a flexible mold in accordance with an illustrative embodiment of the method of preparing an artificial dental prosthetic and seating thereof disclosed herein;

FIG. 4 is a perspective view of an example of a patient's mouth with dental implants having been surgically placed therein in accordance with an illustrative embodiment of the method of preparing an artificial dental prosthetic and seating thereof disclosed herein;

FIG. 5 is a perspective view of an example of a working model formed from an impression of a patient's mouth subsequent to the surgical placement of at least one implant in accordance with an illustrative embodiment of the method of preparing an artificial dental, prosthetic and seating thereof disclosed herein;

FIG. 6 is a perspective view of an example of the working model positioned on a platform of a positive pressure device by which heat and pressure is applied to a sheet of separating film in accordance with an illustrative embodiment of the method of preparing an artificial dental prosthetic and seating thereof disclosed herein;

FIG. 7 shows the working model of FIG. 6 after if has been encapsulated by the sheet of separating film to create a separating mold in accordance with an illustrative embodiment of the method of preparing an artificial dental prosthetic and seating thereof disclosed herein;

FIG. 8 is a perspective view of an example of the flexible mold filled with a temporary material to form a temporary artificial dental prosthetic in accordance with an illustrative embodiment of the method of preparing an artificial dental prosthetic and seating thereof disclosed herein;

FIG. 9 is an exploded view of an example of the temporary artificial dental prosthetic within the flexible mold being seated on the separating mold conforming to the working model in accordance with an illustrative embodiment of the method of preparing an artificial dental prosthetic and seating thereof disclosed herein;

FIG. 10 is an exploded view of an example of a dental refine jig used to orient the flexible mold filled with a curable resinous dental composition onto the working model to form a artificial dental prosthetic in accordance with an illustrative embodiment of the method of preparing an artificial dental prosthetic and seating thereof disclosed herein;

FIG. 11 is a perspective view of an example of removing the separating mold from the intaglio surface of the artificial dental prosthetic in accordance with an illustrative embodiment of the method of preparing an artificial dental prosthetic and seating thereof disclosed herein;

FIG. 12 is a perspective view of an example of hollowing out implant holes in an intaglio surface of the artificial dental prosthetic in accordance with an illustrative embodiment of the method of preparing an artificial dental prosthetic and seating thereof disclosed herein;

FIG. 13 is a perspective view of the artificial dental prosthetic being seated directly onto the implants surgically placed in the patient's mouth in accordance with an illustrative embodiment of the method of preparing an artificial dental prosthetic and seating thereof disclosed herein; and

FIG. 14 is a perspective view of the artificial dental prosthetic seated on the implants surgically placed in the patient's mouth, with a clearance between the intaglio surface of the artificial dental prosthetic and the patient's gingiva in accordance with an illustrative embodiment of the method of preparing an artificial dental prosthetic and seating thereof disclosed herein.

Other advantages and features will be apparent from the following description, and from the claims.

### DETAILED DESCRIPTION OF THE INVENTION

For purposes of illustration and exemplification, the method of preparing an artificial dental prosthetic and seating thereof are shown and described herein with reference to a fully edentulous patient requiring a fixed, full artificial dental prosthetic; however the method of preparing the artificial dental prosthetic and seating thereof should not be so limited to such a class of patients. The method of preparing the artificial dental prosthetic and seating thereof may be used and/or performed on other classes of patients, such as partially dentate patients requiring a fixed, partial artificial dental prosthetic. Other classes of patients may require that one or more diseased or malpositioned teeth be extracted before prosthodontic treatment may proceed, while others may require that some natural teeth be reduced or prepared, but not extracted, to receive the artificial dental prosthetic.

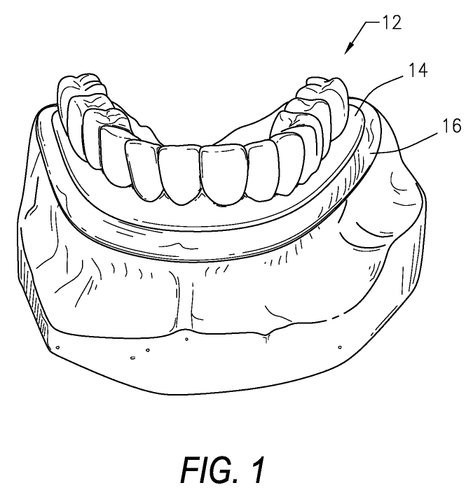

When a patient comes to a practitioner requiring a fixed, full or partial artificial dental prosthetic, the practitioner first identifies and assesses the patient's existing dentition, and if required, the practitioner may extract or reduce one or more of the patient's natural teeth. The practitioner then obtains an impression of the patient's upper arch and/or lower arch without any removable, partial or full dentures in place. As is standard in the dental industry, the impression is formed by placing a soft pliable material into a holder shaped to accommodate the upper arch or the lower arch of the patient. After the holder having the impression material therein is pressed around the patient's teeth and/or gingiva, it is removed and a dental stone, such as plaster, is poured into the impression, resulting in a study mold 10 of the patient's mouth, as shown in FIG. 1. In an edentulous patient having a removable full denture, the study model will replicate the patient's gingiva, whereas, for patients with healthy partial dentition and/or acceptable partial dentures, the study model will replicate the gaps or spaces to be addressed.

As shown in FIG. 1, an ideal dental prosthetic 12 is then prepared on the study model 10. The ideal artificial dental prosthetic 12 may be prepared using at least one reference tooth or arch from a kit or library, by modeling the ideal artificial dental prosthetic 12 after the patient's existing dentition or by modeling the ideal artificial dental prosthetic 12 after the patient's existing prosthesis, such as the patient's existing dentures. A moldable wax 14 may be festooned to hold the ideal artificial dental prosthetic 12 to the study model 10, but should not extend to the buccal vestibules nor cover the patient's palate. A shellac baseplate 16 may be molded onto the gingiva of study model 10, with the moldable wax 14 being added to the baseplate 16.

The moldable wax 14 supporting the ideal artificial dental prosthetic 10 (and the baseplate 16, if utilized) is then inserted into the patient's mouth. A wax bite registration (not shown) is then taken in order to capture the vertical and centric registration of the patient. The practitioner can then mount the study model 10 on an articulator (not shown). With the aid of the wax bite registration and a face bow, the ideal artificial dental prosthetic 12 is related on the articulator. Any excess shellac and/or moldable wax, other than what is required to hold the ideal artificial dental prosthetic 12 in the proper position, may be removed.

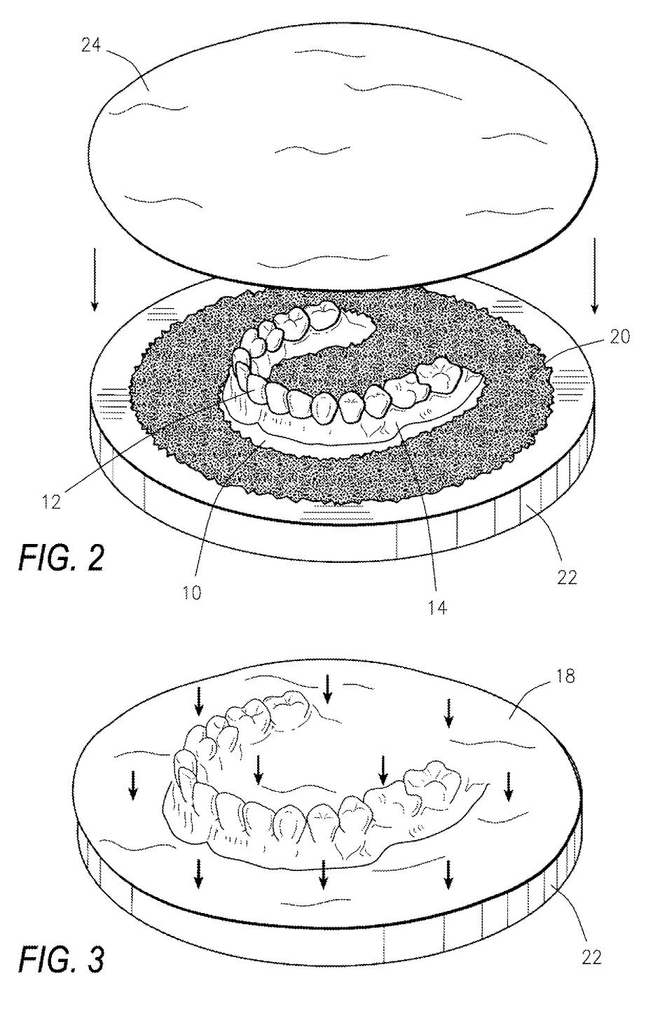

As illustrated in FIG. 2, a flexible mold 18 is made from the ideal artificial dental prosthetic 12 on the study model 10. The flexible mold 18 may be made using a positive pressure device (not shown), such as a Biostar™ (SCHEU-DENTAL, Germany), by placing the study model 10 with the ideal artificial dental prosthetic 12 onto a bed of granular material 20 resting on a platform 20. The study model 10 with the ideal artificial dental prosthetic 12 may then be overlaid under heat and pressure with a sheet of plastic film 24, such as Copyplast™ (SCHEU-DENTAL, Germany). The sheet of plastic film 24 may be transparent, translucent or opaque and may have any desirable thickness, such as 1.0 millimeters. The sheet of plastic film 24 should not bond to acrylic, ceramic or resinous dental compositions. FIG. 3 shows the sheet of plastic film 24 having been heated and forced by air pressure to closely adhere to the external configuration of the study model 10 to form the flexible mold 18. Once the sheet of plastic film 24 has cooled thereby forming the flexible mold 18, the air pressure can be released and the study model 10 having the ideal artificial dental prosthetic 12 and the flexible mold 18 may be removed from the positive pressure device. Upon cooling, the flexible mold 18 is removed from the study model 10 and the ideal artificial dental prosthetic 12. Any excess amount of the plastic film 24 may be trimmed.

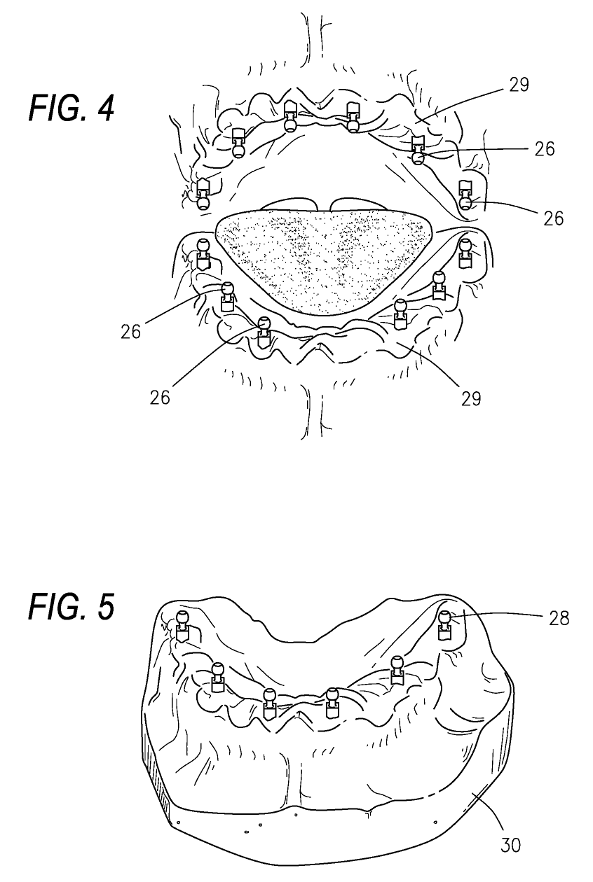

After the practitioner has prepared the study model 10, at least, one implant 26 is surgically placed through the patient's gingiva 29 and into the patient's jaw, as shown in FIG. 4. The implant 26 is surgically inserted using a suitable dental device (not shown), such as a powered contra-angle. The contra-angle keeps the implant 26 concentric, allows the practitioner access to the posterior of the patient's mouth, and also makes placing a large number of implants fast and easy. The implant 26 may be a traditional implant or may be a mini-implant placed in a patient who has a severely atrophied jaw bone for which a traditional implant cannot be placed because of the physical limitations of the patient. The mini-implants, such as MDL™ mini-implants (INTRA-LOCK INTERNATIONAL, INC., Boca Raton, Fla.), may have a diameter of approximately two (2) millimeters to approximately two and a half (2.5) millimeters. The number of implants 26 surgically placed may vary depending upon the particular needs of the individual patient. For example, if the patient is edentulous and has no prior implants, a total of eight (8) to twelve (12) implants may be surgically placed for full upper and lower replacement. The implant 26 may be constructed of any suitable material, such as a titanium alloy allowing for osseointegration.

The surgical placement of the implant 26 may be aided and verified with traditional radiographic (X-rays) images and/or computed tomography (CT) scans. The use of X-rays and/or CT scans enables the practitioner to determine the patient's bone depth, the size and shape of the maxillary sinuses, and the location of nerves associated with the mandibular branch of the trigeminal nerve (inferior alveolar nerve). In addition, the CT scan aids the practitioner in determining the angulation and depth of the implant 26 to be surgically placed. Furthermore, the length of the implant 26 may be chosen in advance using the CT scan.

In surgically placing the implant 26, a pilot hole (not shown) may be created directly through the patient's gingival soft tissues 29. The implant 26 is inserted into the pilot hole using the dental device. During insertion of the implant 26, an insertion-rotation of twenty (20) to thirty (30) revolutions per minute may be maintained. A frequent splash of water on the implant 26 aids in lubricating the placement and controls any excess heat. No flap, incision or suture is required with the placement of the implant 26, resulting in minimal post-operative discomfort to the patient. In addition, parallelism between the implants 26 is not critical in the method of preparing the artificial dental prosthetic and seating thereof. If required, an abutment (not shown) may be used to lengthen the usable part of the implant 26. Upon placement of the implants 26, a torque wrench (not shown) may be utilized to evaluate the implants 26 primary fixation, such as having a torque reading between approximately five (5) and approximately fifty (50) Newton centimeters.

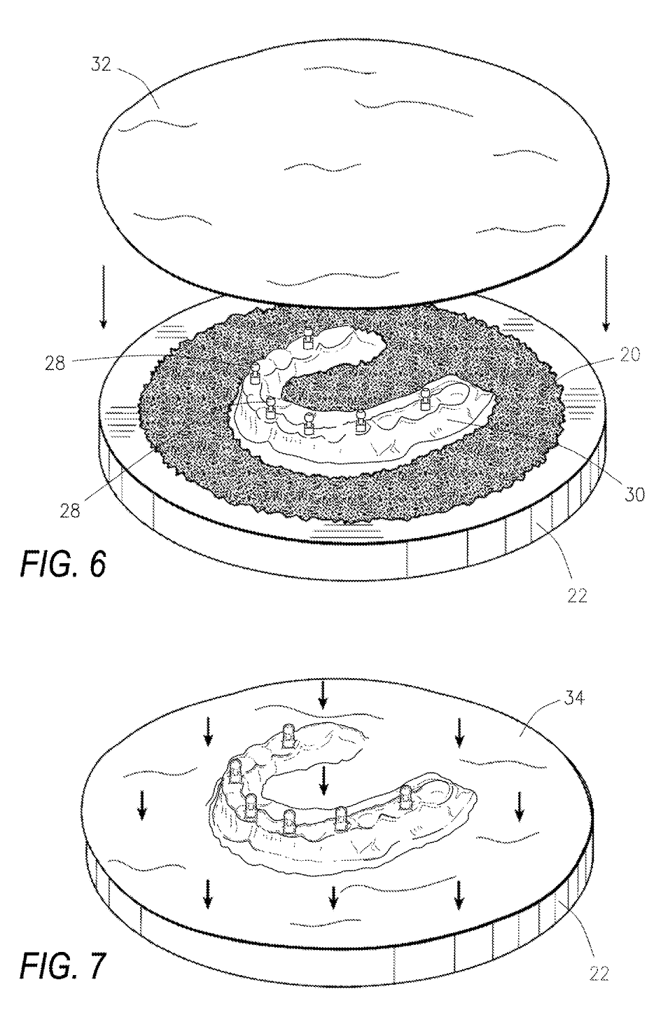

A full arch alginate impression of the patient's upper and/or lower arches may be made after implant 26 insertion is complete. At least one implant analog 28, such as MDL™ Laboratory Analogs (INTRA-LOCK INTERNATIONAL, INC., Boca Raton, Fla.), may be placed into the impression to replicate the implant 26 surgically placed within the patient's mouth. A dental stone, such as plaster, is then poured into the impression to form a working model 30, shown in FIG. 5. A thin sheet of separating film 32 may then be adapted to the working model 30 to form a separating mold 34. Similar to the previously described steps for preparing the flexible mold 18, the working model 30 is placed on onto a bed of granular material 20 resting on the platform 22 of the positive pressure device. The thin sheet of separating film 32, such as Isofolan™ (SCHEU-DENTAL, Germany), is placed over the working model 30, which by application of heat and air pressure is forced to closely conform to the exterior configuration of the working model 30, including the implant analogs 28 if utilized, as illustrated in FIG. 6. The thin sheet of separating film 32 may be transparent, translucent or opaque and may have any desirable thickness, such as 0.1 millimeters. The thin sheet of separating film 32 prevents the acrylic, ceramic and/or resinous dental compositions used herein from bonding or sticking to the working model 30. FIG. 7 shows the thin sheet of separating film 32 having been heated and forced by air pressure to closely adhere to the external configuration of the working model 30 to form the separating mold 34. Once the thin sheet of separating film 32 has cooled thereby forming the separating mold 34, the air pressure can be released and the working model 30 and the separating mold 34 may be removed from the positive pressure device.

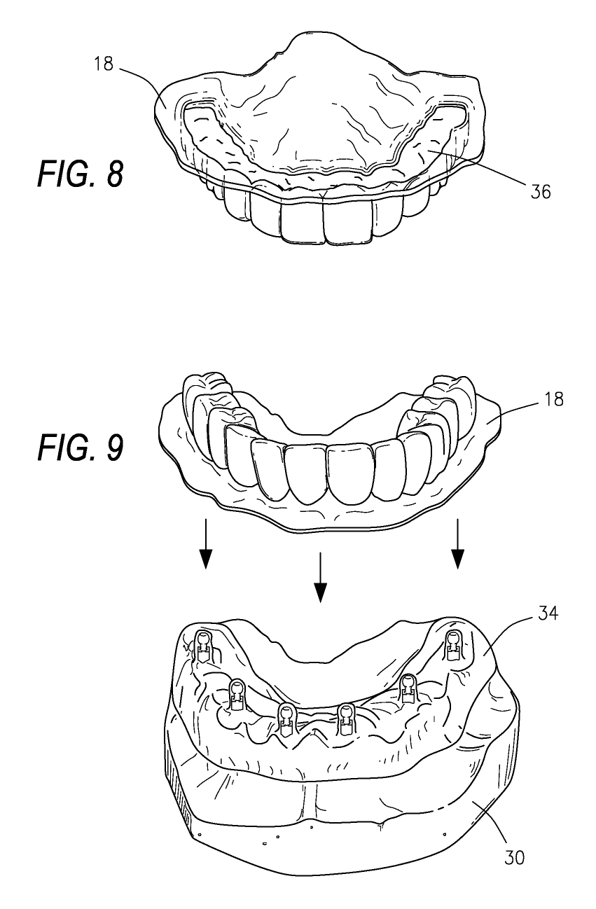

If desirable, such as in the case when the method of preparing the artificial dental prosthetic and seating thereof occurs over a multi-day period, the flexible mold 18 may be filled with a temporary material 36, such as a self-curing poly-methyl-methacrylate (e.g., Coldpac™ (MOTLOID COMPANY, Chicago, Ill.)), or any other dental material for making temporaries or provisionals, to create a temporary artificial dental prosthetic 38. (FIG. 8) An intaglio surface 40 of the temporary artificial dental prosthetic 38 may then be adapted to the separating mold 34 conforming to the external configuration of and seated on the working model 30, as shown in FIG. 9. If implant analogs 28 are utilized in the working model 30, the implant analogs 28 produce implant holes 42 along the intaglio surface 40 of the temporary artificial dental prosthetic 38. The temporary material 36 within the flexible mold 18 is cured or hardened (e.g., by self-curing, photochemically curing, thermally curing or otherwise) to create the temporary artificial dental prosthetic 38. The temporary artificial dental prosthetic 38 is then removed from the working model 30 and the separating mold 34 is removed from the intaglio surface 40 of the temporary artificial dental prosthetic 38. The practitioner then removes the temporary artificial dental prosthetic 38 from the flexible mold 18. Once removed from the flexible mold 18, any excess amount of the temporary material 36 may be removed from the temporary artificial dental prosthetic 38. If implant analogs 28 are utilized to create the working model 30, the implant holes 42 in the temporary artificial dental prosthetic 38 corresponding to the implant analogs 28 may be hollowed out. The temporary artificial dental prosthetic 38 may now be finished and seated onto the implants 26 placed in the patient's mouth. The temporary artificial prosthetic 38 is suitable for use by the patient immediately after implant surgery and could remain in place throughout post-operative healing.

Once the patient is satisfied with the look, feel and function of the temporary artificial dental prosthetic 38, the practitioner makes a face bow transfer of the temporary artificial dental prosthetic 38, refines the esthetics of the temporary artificial dental prosthetic 38 and obtains a wax bite registration (not shown). After the wax bite registration is made, the working model 30 is mounted on the articulator, using the face bow, and the temporary artificial dental prosthetic 38 are then seated on the working model 30. The wax bite registration is then positioned on the temporary artificial dental prosthetic 38 and the upper and the lower arches of the patient may be related using the wax bite registration. Once proper occlusion is accomplished, the working model 30 and the temporary artificial dental prosthetic 38 may be removed from the articulator.

The practitioner may then make a second flexible mold (not shown) of the temporary artificial dental prosthetic 38 while seated on the working model 30. The second flexible mold would be created using the positive pressure device and related steps previously described herein. Based on the professional judgment of the practitioner, the flexible mold 18 used to make the temporary artificial dental prosthetic 38 may be reused to make an artificial dental prosthetic 44 in lieu of making the second flexible mold of the temporary artificial dental prosthetic 38 in order to create the artificial dental prosthetic 44. For illustrative purposes, the following disclosure is described with reference to the use of the flexible mold 18 to create the artificial dental prosthetic 44, but should not be so limited.

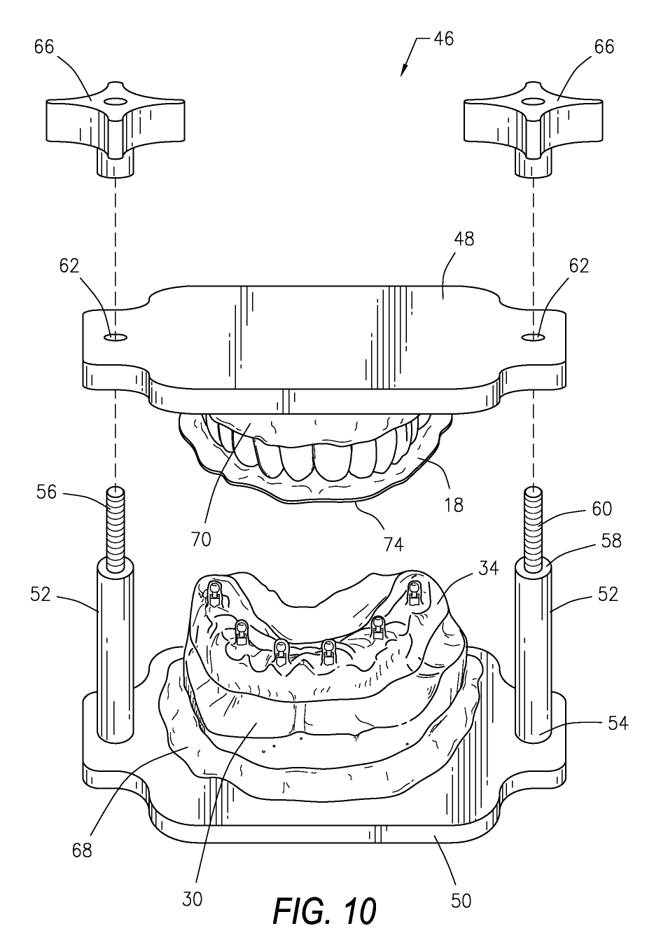

In order to create the artificial dental prosthetic 44, the practitioner may seat and orient the flexible mold 18 onto the working mold 30 with the aid of a dental reline jig 46, as shown in FIG. 10. The jig 46 is ultimately used to orient the flexible mold 18 on the working model 30 when the flexible mold 18 is filled with a curable resinous dental composition 22. The jig 46 comprises a removable top plate 48 and a fixed bottom plate 50, which are held parallel to each other via two parallel posts 52. Each of the parallel posts 52 has opposing ends, with a first opposing end 54 attached to the bottom plate 50 and a second opposing end 56 having a beveled shoulder 58 extending into a reduced diameter, externally threaded section 60. The externally threaded section 60 of each of the posts 52 is capable of being inserted through a respective bore 62 in the top plate 48. Each of the bores 62 in the top plate 48 has a female bevel to correspond to the beveled shoulder 58 of each of the parallel posts 52, thereby allowing positive and precise seating of the top plate 48 on the posts 52. Fasteners 66, such as wing-nuts, can then be tightened onto the externally threaded section 60 of each of the posts 52 to hold the top plate 48 securely against the beveled shoulders 58 of the posts 52, and thus achieve exact parallel positioning of the top plate 48 and the bottom plate 50. The top plate 48 can be easily separated from the bottom plate 50 and the posts 52 by removing the fasteners 66 and lifting the top plate 48.

Initially the flexible mold 18 is carefully oriented and seated on the working model 30 in a precise manner. Plaster is placed on the flexible mold 18 to cover at least the occlusal surfaces of the flexible mold 18. If possible, plaster may be extended to the lateral (labial and buccal) surface and the medial (lingual) surface to provide support to the flexible mold 18. This becomes the plaster mold key 70. Next, the working model 30 with the flexible mold 18 and the mold key 70 is attached to the bottom plate 50 using an additional amount of plaster 68. The top plate 48 should be able to be placed on the parallel posts 52 and fasteners 66 tightened without contacting the mold key 70. Once the plaster 68 attaching the working model 30 to the bottom plate 50 has harden, an additional amount of plaster 68 is applied to the top plate 48. The top plate 48 is then seated onto the parallel posts 52, thereby filling the gap between the mold key 70 and the top plate 48, and the fasteners 66 are tightened. The plaster 68 between the top plate 48 and the mold key 70 is allowed to harden, thereby attaching the flexible mold 18 and the mold key 70 to the top plate 48. The fasteners 66 are then removed and the top plate 48 is unseated from the parallel posts 52, with the mold key 70 and the flexible mold 18 secured to the top plate 48. The flexible mold 18 is filled with a curable resinous dental composition 72 and kept firmly against the mold key 70 to create the artificial dental prosthetic 44. The top plate 48 is then reattached to the jig 46 using the fasteners 66, and thereby accurately seats an intaglio surface 74 of the artificial dental prosthetic 44, as illustrated in FIG. 10, onto the separating mold 34 conforming to the exterior configuration of the working model 30.

In lieu of using the jig 46, the practitioner may physically seat and orient the flexible mold 18 filled with the curable resinous dental composition 72 onto the working mold 30, as illustrated in FIG. 9. As another example, the practitioner may seat the flexible mold 18 filled with the curable resinous dental composition 72 directly onto the implants 26 surgically placed in the patient's mouth, without the use of the jig 46 or the working model 30. However, because of its high degree of accuracy, the practitioner's use of the jig 46 results in fewer defects in and better seating of the artificial dental prosthetic 44 in the patient's mouth as compared with the other examples. For purposes of exemplification, the remaining disclosure is described with respect to the use of the flexible mold 18 intermediately seated on the working model 30, but should not be so limited.

The curable resinous dental composition 72 used to create the artificial dental prosthetic 44 may be curable by any means, such as by light, heat, pressure or self-curing. In addition, the curable resinous dental composition 72 may be any moldable curable resinous dental composition, including but not limited to a composite resin, a hybrid composite resin, a nanohybrid composite resin, a micro-filled composite resin or a flowable composite resin, such as Estelite® (TOKUYAMA CORP., Japan) or Renamel (Cosmedent, Chicago, Ill.). Other suitable, curable materials, such as resin/glass ionomers, sculptable compomers and core buildup materials could also be utilized.

Once the flexible mold 18 is filled with a sufficient amount of the curable resinous dental composition 72 and the intaglio surface 74 of the artificial dental prosthetic 44 is seated onto the separating mold 34 conforming to the exterior configuration, including the implant analogs 28 if utilized, of the working model 30, as shown in FIG. 10 (or seated directly onto the implants 26 surgically placed in the patient's mouth), any superfluous curable resinous dental composition 72 may be massaged out and removed. The curable resinous dental composition 72 is then partially cured, such as by use of an external light source (not shown). The external light source may be a handheld LED caring light in the blue visible spectrum (about 430 nanometers to about 490 nanometers). The curable resinous dental composition 72 may be partially cured for approximately ten (10) seconds so as to give the curable resinous dental composition 72 body, resulting in a partially-cured artificial dental prosthetic 44.

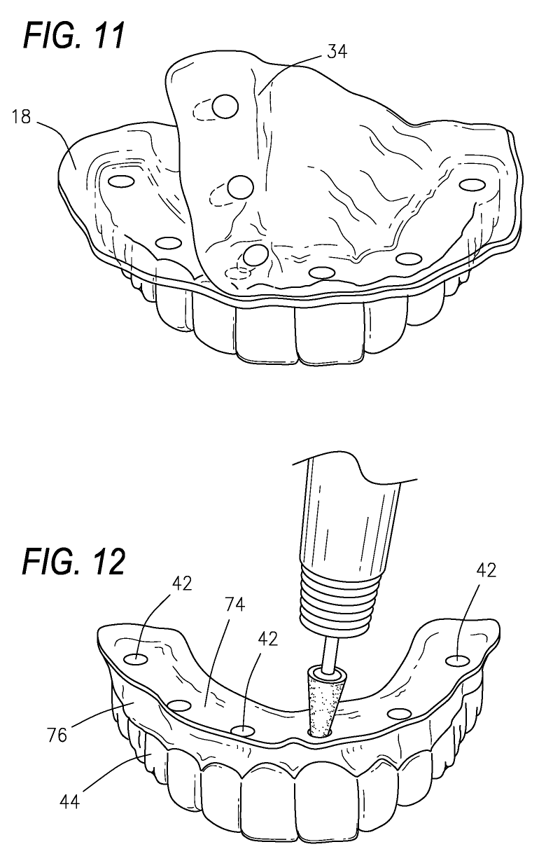

The flexible mold 18 having the partially-cured artificial dental prosthetic 44 is removed from the working model 30, at which point the flexible mold 18 having the partially-cured artificial dental prosthetic 44 is completely cured, such as in a Triad Visible Light Curing Oven (DENTSPLY, York, Pa.), for approximately ten (10) minutes, to form a completely-cured artificial dental prosthetic 44. Once completely cured, the separating mold 34 is removed from the intaglio surface 74 of the completely-cured artificial dental prosthetic 44, as illustrated in FIG. 11. The completely-cured artificial dental prosthetic 44, hereinafter referred to as the artificial dental prosthetic 44, is then removed from the flexible mold 18.

If implant analogs 28 are utilized to create the working model 30, the implant holes 42 in the intaglio surface 74 of the artificial dental prosthetic 44 corresponding to the implant analogs 28 may be hollowed out, as shown in FIG. 12. The artificial dental prosthetic 44 is also finished by refining, shaping and/or polishing using dental laboratory tools and prosthodontic techniques for both aesthetic (e.g., tooth shape, separation and definition) and functional (e.g., bite refinements, removing excess bulk to ensure patient comfort) purposes. A gingival shade may also be added to a gingival portion 76 the artificial dental prosthetic 44 to make the artificial dental prosthetic 44 look more esthetically pleasing and truthful in the patient's mouth.

In addition to the aforementioned finishing and as shown in FIG. 14, the gingival portion 76 of the artificial dental prosthetic 44 may be tapered and/or trimmed in order to minimize any contact between the intaglio surface 74 of the gingival portion 76 of the artificial dental prosthetic 44 and the gingiva 29 of the patient's mouth. A clearance 78 of approximately less than four (4) millimeters may be provided between the intaglio surface 74 of the gingival portion 76 of the artificial dental prosthetic 44 and the gingival tissues 29 of the patient, thereby allowing the patient to maintain good oral hygiene, such as by allowing cleansing with a toothbrush or a water-irrigating device intermediate of the artificial dental prosthetic 44 and the patient's gingiva 29.

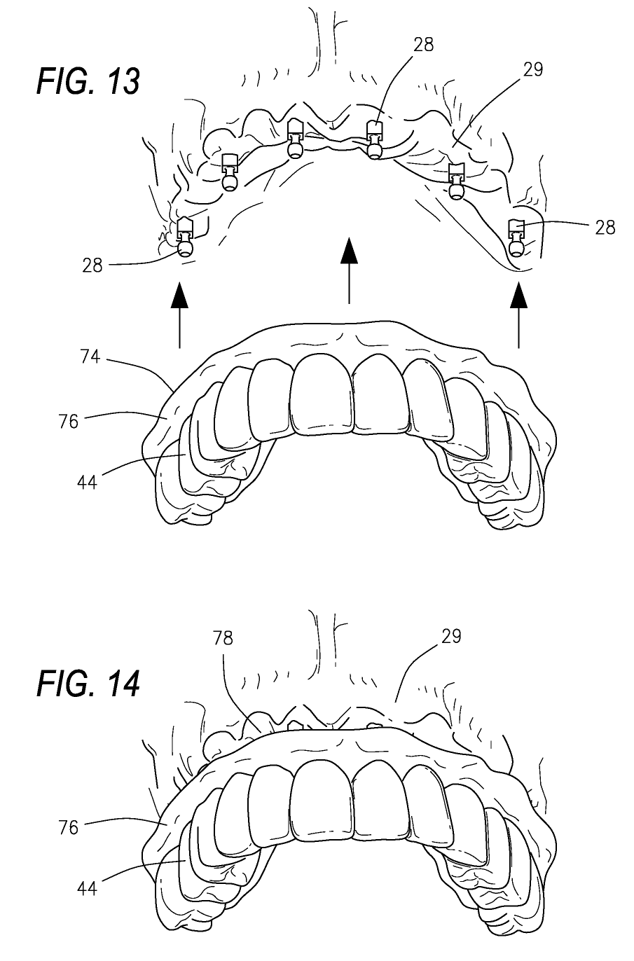

An additional amount of the curable resinous dental composition may be placed within the implant holes 42 and the artificial dental prosthetic 44 directly seated onto the implants 26 surgically placed in the patient's mouth (FIG. 13). Any excess amount of the additional resin may be removed and the artificial dental prosthetic 44 may be cured directly onto the implants 26 in the patient's mouth. By placing the additional amount of the curable resinous dental composition into the implant holes 42, the artificial dental prosthetic 44 is rigidly seated directly and fixed onto the implants 26 in the patient's mouth. If during the course of treatment it is determined that the patient has progressive bone loss, an abutment (not shown) may be utilized to lengthen the implant 26 in the patient's mouth so as extend the area of the implant 26 upon which the artificial dental prosthetic 44 is to be seated. In such as case, the artificial dental prosthetic 44 may be rigidly seated directly and fixed on the abutment of the implant 26 in the patient's mouth.

While the devices and methods have been described in relation to the drawings and claims with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification, but is limited only by the scope of the attached claim or claims, including the full range of equivalency to which each element thereof is entitled.

What is claimed is:

1. A method for preparing an artificial dental prosthetic, comprising the steps of:
(1) making a study model from an impression of a patient's mouth; wherein said patient's mouth does not have a removable partial or full denture in place;
(2) preparing an ideal artificial dental prosthetic on said study model;
(3) making a flexible mold of said ideal artificial dental prosthetic on said study model;
(4) filling said flexible mold with a curable resinous dental composition to form an artificial dental prosthetic;
(5) curing said curable resinous dental composition to form said artificial dental prosthetic; and
(6) tapering a gingival portion of said artificial dental prosthetic so as to minimize contact between an intaglio surface of said gingival portion of said artificial dental prosthetic and the gingival soft tissues of said patient's mouth.

2. The method of claim 1 wherein said step (2) of preparing said ideal artificial dental prosthetic is carried out by waxing up at least one reference tooth or arch from a kit or library, modeling said ideal artificial dental prosthetic after said patient's existing dentition or modeling said ideal artificial dental prosthetic after said patient's existing dental prosthetic.

3. The method of claim 1 wherein said step (2) of preparing said ideal artificial dental prosthetic further comprises the steps of:
(1) making a vertical and centric bite registration of said patient's mouth without any removable partial or full dentures in place;
(2) mounting said study model to an articulator; and
(3) preparing said ideal artificial dental prosthetic on said study model to spatially conform to said bite registration using said articulator.

4. The method of claim 1 wherein said step (3) of making said flexible mold is carried out using a positive pressure device to heat and force a sheet of film onto said study model and said ideal artificial dental prosthetic.

5. The method of claim 1 further comprising the steps of:
(1) making a second impression of said patient's mouth, wherein said patient's mouth has said at least one implant;
(2) placing at least one implant analog into said second impression; and
(3) making a working model of said second impression having said at least one implant analog.

6. The method of claim 5 further comprising the steps of making a separating mold conforming to said working model using a positive pressure device to heat and force a sheet of separating film onto said working model.

7. The method of claim 6 further comprising the steps of:
(1) filling said flexible mold with said curable resinous dental composition to form said artificial dental prosthetic;
(2) seating an intaglio surface of said artificial dental prosthetic in said flexible mold on said separating mold conforming to said working model;
(3) removing any excess amount of said curable resinous dental composition from said flexible mold and said working model;
(4) partially curing said curable resinous dental composition in said flexible mold forming a partially-cured artificial dental prosthetic;
(5) removing said partially-cured, artificial dental prosthetic from said working model;
(6) completely curing said partially-cured artificial dental prosthetic to form a completely-cured artificial dental prosthetic;
(7) removing said separating mold from said intaglio surface of said completely-cured artificial dental prosthetic;
(8) removing said completely-cured artificial dental prosthetic from said flexible mold; and
(9) finishing said completely-cured artificial dental prosthetic.

8. The method of claim 7 further comprising the steps of:
(1) orienting and seating said flexible mold on said working model;
(2) making a mold key by covering at least an occlusal surface of said flexible mold with a dental plaster;
(3) attaching said working model with said flexible mold and said mold key to a bottom plate of a jig;
(4) attaching said mold key to a top plate of said jig;
(5) removing said top plate having attached said mold key and said flexible mold from said jig;
(6) filling said flexible mold with said curable resinous dental composition to form said artificial dental prosthetic;
(7) attaching said top plate having attached said mold key and said flexible mold filled with said curable resinous dental composition to said jig; and
(8) seating said intaglio surface of said artificial dental prosthetic in said flexible mold using said mold key and said jig to said working model.

9. The method of claim 8 wherein said step (2) of making said mold key further comprises the steps of:
(1) covering said occlusal surface, a lateral surface and a medial surface of said flexible mold with said dental plaster; and
(2) allowing said dental plaster to harden to form said mold key.

10. The method of claim 8 wherein said step (3) of attaching said working model to said bottom plate further comprises the steps of:
(1) using an additional amount of said dental plaster to attach said working model to said bottom plate of said jig; and
(2) allowing said additional amount of said plaster to harden.

11. The method of claim 8 wherein said step (4) of attaching said mold key to said top plate further comprises the steps of:
(1) using an additional amount of said dental plaster to attach said mold key to said top plate of said jig; and
(2) allowing said additional amount of said plaster to harden.

12. The method of claim 7 wherein said step (2) of seating said intaglio surface of said artificial dental prosthetic further comprises the step of massaging any excess amount of said curable resinous dental composition out of said flexible mold.

13. The method of claim 7 wherein said step (9) of finishing said completely-cured artificial dental prosthetic further comprises the steps of:
(1) shaping, polishing and adding gingival shade to said completely-cured artificial dental prosthetic;
(2) hollowing out at least one implant hole on said intaglio surface of said completely-cured artificial dental prosthetic, wherein said at least one implant hole is formed from said at least one implant analog of said working model; and
(3) tapering a gingival portion of said completely-cured artificial dental prosthetic so as to minimize contact between said intaglio surface of said gingival portion of said completely-cured artificial dental prosthetic and said gingival soft tissues of said patient's mouth.

14. The method of claim 1 wherein said step (6) of tapering said gingival portion of said artificial dental prosthetic further comprises the step of trimming said gingival portion of said artificial dental prosthetic to form a clearance of less than approximately 4 millimeters between said intaglio surface of said gingival portion of said artificial dental prosthetic and said gingival soft tissues of said patient's mouth.

15. The method of claim 1 wherein said curable resinous dental composition is a composite resin, a hybrid composite resin, a nanohybrid composite resin, a micro-filled composite resin or a flowable composite resin.

16. The method of claim 15 wherein said curable resinous dental composition is photochemically curable, thermally curable or self-curing.

17. The method of claim 1 wherein said artificial dental prosthetic comprises a unitary, fixed foil denture or a fixed partial denture.

18. The method of claim 1 wherein said artificial dental prosthetic is prepared to seat directly on at least one implant surgically placed in a patient's mouth.

19. A method for preparing and seating an artificial dental prosthetic, comprising the steps of:
(1) making a study model from an impression of a patient's mouth; wherein said patient's mouth does not have a removable partial or full denture in place;
(2) preparing an ideal artificial dental prosthetic on said study model;
(3) making a flexible mold of said ideal artificial dental prosthetic on said study model;
(4) surgically placing at least one implant in said patient's mouth;
(5) filling said flexible mold with a curable resinous dental composition to form an artificial dental prosthetic;
(6) curing said curable resinous dental composition filling said flexible mold; and
(7) seating said artificial dental prosthetic directly on said at least one implant in said patient's mouth.

20. The method of claim 19 wherein said step (2) of preparing said ideal artificial dental prosthetic is carried out by waxing up at least one reference tooth or arch from a kit or library, modeling said ideal artificial dental prosthetic after said patient's existing dentition or modeling said ideal artificial dental prosthetic after said patient's existing dental prosthetic.

21. The method of claim 19 wherein said step (3) of making said flexible mold is carried out using a positive pressure device to heat and force a sheet of film onto said study model and said ideal artificial dental prosthetic.

22. The method of claim 19 wherein step (4) of surgically placing said at least one implant further comprises the steps of:
(1) identifying and assessing said patient's natural teeth and existing dental implants, if present;
(2) performing at least one computed tomography scan of said patient's mouth;
(3) extracting one or more of said patient's natural teeth, if required; and
(4) surgically placing said at least one implant in said patient's mouth.

23. The method of claim 19 wherein said at least one implant is a mini-implant having a diameter of approximately 2.0 millimeters to approximately 2.5 millimeters.

24. The method of claim 19 further comprising the steps of:
(1) making a second impression of said patient's mouth, wherein said patient's mouth has said at least one implant;
(2) placing at least one implant analog into said second impression; and
(3) making a working model of said second impression having said at least one implant analog.

25. The method of claim 24 further comprising the steps of making a separating mold conforming to said working model using a positive pressure device to heat and force a sheet of separating film onto said working model.

26. The method of claim 25 further comprising the steps of:
(1) filling said flexible mold with a temporary material to create a temporary artificial dental prosthetic;
(2) seating an intaglio surface of said temporary artificial dental prosthetic in said flexible mold onto said separating mold conforming to said working model; and
(3) curing said temporary artificial dental prosthetic to form a cured-temporary artificial dental prosthetic.

27. The method of claim 26 wherein said step (3) of curing said temporary artificial dental prosthetic further comprises the steps of:
(1) removing said cured-temporary artificial dental prosthetic from said working model;
(2) removing said separating mold from said intaglio surface of said cured-temporary artificial dental prosthetic;
(3) removing said cured-temporary artificial dental prosthetic from said flexible mold;
(4) trimming any excess amount of said temporary material from said cured-temporary artificial dental prosthetic; and
(5) hollowing out at least one implant hole on said intaglio surface of said cured-temporary artificial dental prosthetic, wherein said at least one implant hole is formed from said at least one implant analog of said working model.

28. The method of claim 27 further comprising the step of seating said cured-temporary artificial dental prosthetic in said patient's mouth.

29. The method of claim 28 further comprising the steps of:
(1) obtaining a vertical and centric bite registration using said cured-temporary artificial dental prosthetic seated in said patient's mouth;
(2) removing said cured-temporary artificial dental prosthetic and said bite registration from said patient's mouth;
(3) mounting said working model on an articulator using a face bow;
(4) positioning said cured-temporary artificial dental prosthetic and said bite registration on said working model, respectively; and
(5) relating said cured-temporary artificial dental prosthetic using said bite registration and said face bow of said articulator.

30. The method of claim 25 further comprising the steps of:
(1) filling said flexible mold with said curable resinous dental composition to form said artificial dental prosthetic;
(2) seating an intaglio surface of said artificial dental prosthetic in said flexible mold on said separating mold conforming to said working model;
(3) removing any excess amount of said curable resinous dental composition from said flexible mold and said working model;
(4) partially curing said curable resinous dental composition in said flexible mold forming a partially-cured artificial dental prosthetic;
(5) removing said partially-cured, artificial dental prosthetic from said working model;
(6) completely curing said partially-cured artificial dental prosthetic to form a completely-cured artificial dental prosthetic;
(7) removing said separating mold from said intaglio surface of said completely-cured artificial dental prosthetic;
(8) removing said completely-cured artificial dental prosthetic from said flexible mold; and
(9) finishing said completely-cured artificial dental prosthetic.

31. The method of claim 30 further comprising the steps of:
(1) orienting and seating said flexible mold on said working model;
(2) making a mold key by covering at least an occlusal surface of said flexible mold with a dental plaster;
(3) attaching said working model with said flexible mold and said mold key to a bottom plate of an dental reline jig;
(4) attaching said mold key to a top plate of said jig;
(5) removing said top plate having attached said mold key and said flexible mold from said jig;
(6) filling said flexible mold with said curable resinous dental composition to form said artificial dental prosthetic;
(7) attaching said top plate having attached said mold key and said flexible mold filled with said curable resinous dental composition to said jig; and
(8) seating said intaglio surface of said artificial dental prosthetic in said flexible mold using said mold key and said jig to said working model.

32. The method of claim 31 wherein said step (2) of making said mold key further comprises the steps of:
(1) covering said occlusal surface, a lateral surface and a medial surface of said flexible mold with said dental plaster; and
(2) allowing said dental plaster to harden to form said mold key.

33. The method of claim 31 wherein said step (3) of attaching said working model to said bottom plate further comprises the steps of:
(1) using an additional amount of said dental plaster to attach said working model to said bottom plate of said jig; and
(2) allowing said additional amount of said plaster to harden.

34. The method of claim 31 wherein said step (4) of attaching said mold key to said top plate further comprises the steps of:
(1) using an additional amount of said dental plaster to attach said mold key to said top plate of said jig; and
(2) allowing said additional amount of said plaster to harden.

35. The method of claim 30 wherein said step (2) of seating said intaglio surface of said artificial dental prosthetic further comprises the step of massaging any excess amount of said curable resinous dental composition out of said flexible mold.

36. The method of claim 30 wherein said step (9) of finishing said completely-cured artificial dental prosthetic further comprises the steps of:
(1) shaping, polishing and adding gingival shade to said completely-cured artificial dental prosthetic;
(2) hollowing out at least one implant hole on said intaglio surface of said completely-cured artificial dental prosthetic, wherein said at least one implant hole is formed from said at least one implant analog of said working model; and
(3) tapering a gingival portion of said completely-cured artificial dental prosthetic so as to minimize contact between said intaglio surface of said gingival portion of said completely-cured artificial dental prosthetic and the gingival soft tissues of said patient's mouth.

37. The method of claim 36 further comprising the step of tapering said gingival portion of said artificial dental prosthetic to form a clearance of less than approximately 4 millimeters between said intaglio surface of said gingival portion of said artificial dental prosthetic and said gingival soft tissues of said patient's mouth.

38. The method of claim 36 further comprising the steps of:
(1) adding an additional amount of said curable resinous dental composition to said at least one implant hole in said completely-cured artificial dental prosthetic;
(2) seating said completely-cured artificial dental prosthetic directly on said at least one implant in said patient's mouth;
(3) removing any excess amount of said additional curable resinous dental composition; and
(4) curing said additional curable resinous dental composition directly onto said at least one implant in said patient's mouth.

39. The method of claim 19 wherein said curable resinous dental composition is a composite resin, a hybrid composite resin, a nanohybrid composite resin, a micro-filled composite resin or a flowable composite resin.

40. The method of claim 39 wherein said curable resinous dental composition is photochemically curable, thermally curable or self-curing.

41. The method of claim 38 wherein said additional curable resinous dental composition is a composite resin, a hybrid composite resin, a nanohybrid composite resin, a micro-filled composite resin or a flowable composite resin.

42. The method of claim 41 wherein said curable resinous dental composition is photochemically curable, thermally curable or self-curing.

43. The method of claim 26 wherein said temporary material is a poly-methyl-methacrylate.

44. The method of claim 19 wherein said artificial dental prosthetic comprises a unitary, fixed full denture or a fixed partial denture.

45. The method of claim 19 wherein said step (7) of seating said artificial dental prosthetic precedes said step (6) of curing said curable resinous dental composition.
